(19) United States
(12) Patent Application Publication
(10) Pub. No.: US 2002/0129554 A1
(43) Pub. Date: Sep. 19, 2002

(54) Flange-shaped fitting frame

(75) Inventor: Ritske Johannes van Leeuwen, Delft (NL)

Correspondence Address: VARNUM, RIDDERING, SCHMIDT & HOWLETT LLP, P.O. BOX 352, GRAND RAPIDS, MI, 49501, US

(73) Assignee: Bruynzeel Plastics B.V.

(21) Appl. No.: 10/038,380

(22) Filed: Dec. 21, 2001

Related U.S. Application Data
(60) Provisional application No. 60/258,573, filed on Dec. 27, 2000.

(51) Int. Cl. E05D 15/38

(52) U.S. Cl. 49/197

(57) ABSTRACT

A device for sealing a door or window casing by means of an insect-repellent gauze screen. The device comprises a rectangular insect-repellent gauze screen that is secured with one end to a roller rod, around which it can be wound and unwound, and with the other end to a pulling beam, which is provided with two handles. The roller rod is accommodated in a first frame section to be placed vertically. The pulling beam can be slid against a second frame section to be placed opposite the first frame section. The device further comprises a third and a fourth frame section, which possess a U-shaped guide section, in which an edge of the gauze screen is guided. The device comprises securing means so as to enable the fitting of the frame sections before the casing. The securing means are mounted on an inner wall of the casing, in particular on the transverse side of decorative parts present around the easing.

This invention relates to a device for seating a door or window casing by means of an insect-repellent gauze screen, comprising an insect-repellent gauze screen that is secured with one end to a roller rod, around which it can be wound and unwound, and with the other end to a pulling beam, which roller rod is accommodated in a first frame section, and which pulling beam can be slid against a second frame section to be placed opposite the first frame section, further comprising a third and a fourth frame section, which possess a U-shaped guide section, in which guide sections the pulling beam and an edge of the gauze screen can be guided, which device comprises securing means so as to enable the fitting of the frame sections before the casing.

Such a device, also called a roller screen, is described in European application 0 086 023. A problem when mounting these devices is that on the door or window casing a flat and relatively large securing surface must be present for securing the construction. This imposes requirements on the type of casing for which the devices are suitable. In particular for a casing with decorative parts fitted around it, as is usual in America, it is not possible very well to mount the conventional roller screens. Furthermore, a construction in which the device is mounted nearly completely in the passage opening has the drawback that the passage opening is substantially reduced.

It is an object of the invention to avoid the above problem and to provide a device that can also be fitted to surfaces on which the presence of decorative parts hinders the mounting of conventional devices.

This object is achieved by a device of the type mentioned in the opening paragraph, in which the securing means can be mounted on an inner wall of the casing, in particular on the transverse side of decorative part present around the casing. This ensures that, in spite of decorative parts that may be present or other objects present on the front face of the casing, a robust securing can be realized, with no or substantially no narrowing of the passage width of the casing. The invention has the advantage that the mounting surface may be relatively small. The invention particularly offers advantages as roller screen door, that is to say in an embodiment in which the first frame section is placed vertically. Although the securing means may be formed, for instance, by separate securing brackets to be secured to the inner wall, the securing means preferably comprise a securing edge extending in the longitudinal direction of a frame section, which securing edge, in mounted condition, forms a seal abutting the inner wall of the casing. This embodiment has the advantage that the frame sections can seal the casing nearly completely, which improves the insect-repellent effect of the device.

A threshold section can be secured to a frame section, which threshold section, in cooperation with a threshold, can form a continuous threshold face. Preferably, the threshold section has, on a first longitudinal side, a projecting section edge that can engage the frame section, and the threshold section has a gripping edge, which, in cooperation with the section edge, can be secured to a side of the frame section. The threshold section may decrease in height in the direction of the first longitudinal side towards the opposite side, corresponding to a threshold part increasing in height. By using a threshold section, a frame section mounted before a threshold can be prevented from poorly abutting the threshold, which is visually unattractive or may be dangerous.

The pulling beam may be provided with a slot in which, at the ends, strip-shaped suspension elements are adjustably mounted. The suspension elements possess a section that can slidably hook into the guide section. The suspension elements offer an adjusting possibility, so that the height of the frame sections can be adapted to the casing and a proper seal can be obtained.

Further advantages and properties of the invention will be illustrated with reference to the accompanying drawing. In this drawing:

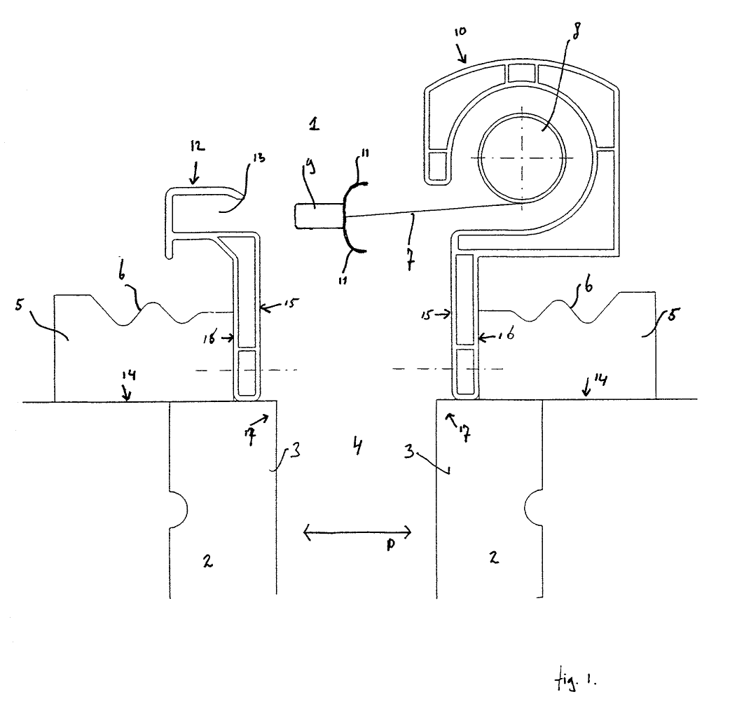

FIG. 1 diagrammatically shows, viewed in cross-section, a device according to the invention, mounted on a casing provided with decorative parts;

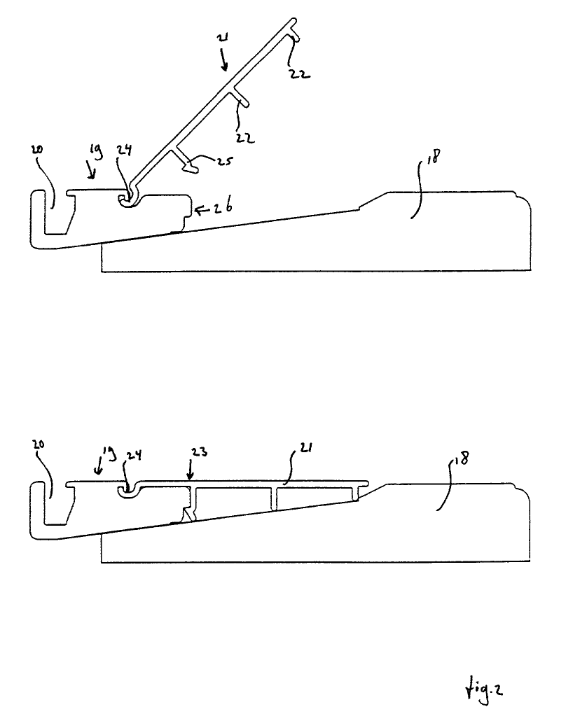

FIGS. 2a and 2b show a diagrammatic cross-section of a threshold section of the device according to the invention; and

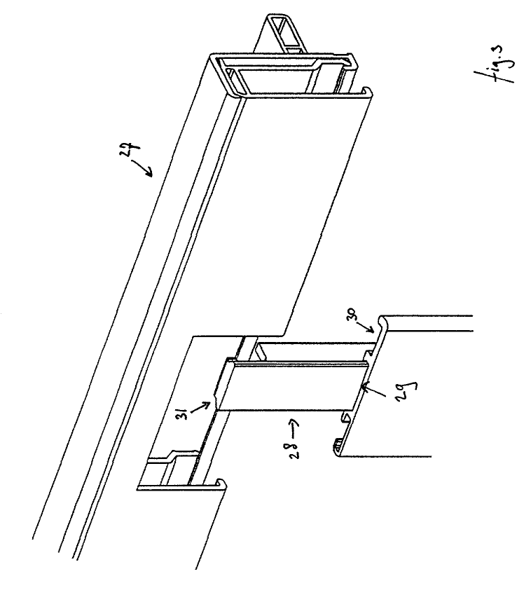

Fig. 3 shows, in detail, a pulling beam, provided with a slot with a strip-shaped suspension element therein.

In the figures, similar parts are designated by the same reference numerals.

The device of FIG. 1, hereinafter called roller screen door 1, is fitted in the casing 2. Reference numerals 3 designate the vertical standing parts (door post) of the casing. The arrow P designates the passage opening 4; for clarity's sake, the standing parts 3 are shown at a short distance from each other. Secured to the front of the casing 2 are decorative parts 5. Such decorative parts 5 may be provided with a relief, which is diagrammatically shown by the line 6.

The roller screen door 1 according to the invention further comprises an insect-repellent gauze screen 7, which is secured with one end to a roller rod 8 and can be wound around it and unwound from it, and which is secured with the other end to a pulling beam 9. The roller rod comprises, at one end, a spiral spring (not shown) and is enclosed by an elongate, substantially U-shaped frame section 10, which is placed vertically parallel to one of the parts 3. The pulling beam 9 is guided in a U-shaped guide section (not shown), explained in more detail with reference to FIG. 3.

The pulling beam 9 is further provided with two handles 11. The pulling beam 9 can be slid against a second frame section 12 to be placed opposite the holder 10, so that an insect-repellent seal is obtained. The section 12 can be provided, in a manner known per se, with a closing mechanism 13 to lock the pulling beam in the closed position. By the presence of the relief 6, it is not possible very well to mount the roller screen door 1 on the outer surface 14 of the casing 2. The roller screen door 1 according to the invention therefore has a flange-shaped securing edge 15, with which the frame sections can be fitted before the casing. The securing edge 15 can be mounted on the transverse side to of decorative parts present around the casing. Optionally, in the absence of such a transverse edge 16, the securing edge may also be mounted on a part 17 of a casing edge 3. Of course, this has the drawback that the passage opening is slightly reduced.

FIG. 2 shows, in cross-section, a threshold 18. As is usual, the threshold decreases in height towards the front of the casing. A frame section 19 with a U-shaped guide section 20, in which (not shown) the pulling beam and an edge of the gauze screen can be guided, is secured to the threshold 18. The presence of this frame section forms a visually less attractive or even dangerous step before the threshold. For this reason, a threshold section 21 is provided (also shown in cross-section). On the threshold section 21, reinforcing transverse ribs 22 are provided. The threshold section 21 decreases in height, so that, in cooperation with the rising threshold, a continuous threshold face 23 is formed. The threshold section 21 can be secured, because on a longitudinal side a projecting section edge 24 is present, which can engage the frame section 19, in cooperation with a flipping edge 25, which can be gripped on a side 26 of the threshold section 19. FIG. 2a shows how the section edge 24 engages the frame section 19. FIG. 2b shows the threshold section in the gripped horizontal position

FIG. 3 finally shows how a pulling beam 9 is guided in a U-shaped guide section 27. This takes place by means of strip-shaped suspension elements 28, which are adjustably mounted in a slot 29 of the pulling beam 9. The figure shows the side 30 of the pulling beam 9 in shortened form, so that the suspension elements can be shown; the pulling beam continues into the U-shaped section 27. The suspension elements possess a section 31, which can slidably hook into the guide section 9.

The invention is not limited to the exemplary embodiments shown in the figures, but may comprise all kinds of variations and modifications thereof, of course as far as falling within the scope of protection of the appended claims.

1. A device for sealing a door or window casing by means of an insect-repellent gauze screen, comprising an insect-repellent gauze screen that is secured with one end to a roller rod, around which it can be wound and unwound, and with the other end to a pulling beam, which roller rod is accommodated in a first frame section, and which pulling beam can be slid against a second frame section to be placed opposite the first frame section, further comprising a third and a fourth frame section, which possess a U-shaped guide section in which guide sections the pulling beam and an edge of the gauze screen can be guided, which device comprises securing means so as to enable the fitting of the frame sections before the casing, characterized in that the securing means can be mounted on an inner wall of the casing, in particular on the transverse side of decorative parts present around the casing.

2. A device according to claim 1, characterized in that the first frame section is placed vertically

3. A device according to claim 1 or 2, characterized in that the securing means comprise a securing edge extending in the longitudinal direction of a frame section, which securing edge, in mounted condition, forms a seal abutting the inner wall of the casing.

4. A device according to at least one of claims 1-3, characterized in that a threshold section can be secured to a U-shaped frame section, which threshold section has, on a longitudinal side, a projecting section edge that can engage the frame section, and which has a gripping edge, which, in cooperation with the section edges can be secured to a side of the frame section.

5. A device according to claim 4, characterized in that the threshold section decreases in height in the direction of the first longitudinal side towards the opposite side, so that, in cooperation with a threshold, a continuous threshold face can be formed.

6. A device according to any one of the preceding claims, characterized in that the pulling beam is provided with a slot in which, at the ends, strip-shaped suspension elements are adjustably mounted, which suspension elements possess a section that can slidably hook into a guide section.
